(19) United States
(12) Patent Application Publication
(10) Pub. No.: US 2012/0004897 A1
(43) Pub. Date: Jan. 5, 2012

(54) Operation Training Simulation Apparatus for Computer Numerical Control Machine

(75) Inventor: Frank Chen, Taichung (TW)

(73) Assignee: REN AN INFORMATION TECHNOLOGY CO., LTD., TAICHUNG (TW)

(21) Appl. No.: 12/672,898

(22) PCT Filed: Aug. 19, 2008
(86) PCT No.: PCT/CN2008/001489

§ 371 Date: Feb. 10, 2010

(30) Foreign Application Priority Data
Aug. 21, 2007 (CN) 200710140778.2

(51) Int. Cl. G06F 13/10

(52) U.S. Cl. 703/21

(57) ABSTRACT

An operation training simulation apparatus for a computer numerical control (CNC) machine includes a CNC casing assembly, a control panel device for inputting control and operation commands, a software simulator connected with the simulated control panel displayer, and a simulation displayer electrically connected to the software simulator. The casing assembly includes a CNC frame body. The control panel device is mounted on the casing assembly and has a realistic function control panel interface and a realistic operation control panel interface. The software simulator generates machining and operation simulations based on the inputted control and operation commands through the control panel device, and the simulation displayer visualizes the machining and operation simulations generated by the software simulator.

### CROSS-REFERENCE TO RELATED APPLICATION

This application claims priority to PCT Application No. PCT/CN2008/001489, filed Aug. 19, 2008, which claims priority to CN Application No. 200710140778.2, filed Aug. 21, 2007.

### FIELD OF DISCLOSURE

The present disclosure relates to an operation training simulation apparatus for a tool machine, and particularly relates to an operation training simulation apparatus for a computer numerical control (CNC) machine.

### DESCRIPTION OF RELATED ART

Many computer aid design and computer aid manufacturing (CAD/CAM) software are developed to assist the complex producing process of the tool machine. The software, such as the Pro-E, UG and Gibbs CAM, enable a user to simulate the producing process of the tool machine before a workpiece is manufactured. They enable the user to pre-run the process and thus to find out mistakes before a workpiece being processed. Therefore, the software become very popular in the manufacturing industry since they save raw materials and prevent damages of the tool machine.

However, the more powerful the software are, the more complex to use them. A user has to remember many complex command codes of the software and to get familiar with the interfaces of the tool machine before using them. The computer numerical control (CNC) machine is particularly a useable tool machine, but the corresponding software requires the user to edit complex command codes. On the other hand, the simulation software for the CNC tool machine costs a lot, it requires much time and cost to train a CNC operator.

When the simulation software is applied to train the user to be able to edit the command codes, the cost and risk are diminished. But the user still doesn't become familiar with the operation interface of the CNC tool machine even if he did remember many command codes.

Therefore, before a user really becomes a CNC tool machine operator, it is necessary to spend time to become familiar with the operation interface, i.e. the operation panels.

In a school or labor training center, the economic efficiency is very low to buy a CNC tool machine merely for training. Even if they did buy a CNC tool machine merely for training, many users have to share it. Therefore, they don't have enough time and chance to get familiar with the operation interface.

Another way to train the users is using the control box demounted from the CNC tool machine. The control boxes are much cheaper, and the school or labor training center can buy more. However, merely the control box cannot let the user to know what a really tool machine will do when they key-in a particular command code.

The other way to train the users is so called on-job-training (OJT). Many factories train the users on their daily job, but it takes a lot of risk.

The risk is not merely the wasted raw material but also the damages of the tool machine caused by mistake operations. More important, people may also get hurt due to their mistake operations.

One better way to solve the drawbacks described above is using the computer to imitate an operation interface and also to simulate the result of the command codes. However, the computer cannot provide a simulation CNC working environment to the user. The learning efficiency is therefore very poor.

Therefore, the market requires a new device to solve the drawbacks described above, and to provide a safe environment to the user to get familiar with the CNC tool machine.

### SUMMARY OF THE DISCLOSURE

One aspect of the disclosure is to provide an operation training simulation apparatus for the computer numerical control (CNC) machine. The operation training simulation apparatus combines an imitated CNC operation interface with a simulation displayer to provide a simulation CNC working environment to train a user. The operation training simulation apparatus not only helps the user to become familiar with the CNC operation interface, but also helps the user to become familiar with the producing process controlled by the command codes. Therefore, the user doesn't need to image and recognize the complex software codes of the simulator, but to operate the simulator via the imitated interfaces directly.

Another aspect of the disclosure is to provide an operation training simulation apparatus that has the same outer shape and appearance with a real CNC tool machine. It establishes a simulation CNC working environment to the user, and lets the user feel like being operating a real CNC tool machine.

According to one aspect of the disclosure, an operation training simulation apparatus for the computer numerical control (CNC) machine is disclosed.

The operation training simulation apparatus includes a CNC casing assembly, a control panel device, a software simulator and a simulation displayer.

The CNC casing assembly has a CNC frame body. The control panel device is mounted on the CNC casing assembly and has a CNC control panel interface. The CNC control panel interface has an operation imitating area, and the operation imitating area has a realistic function control interface and a realistic operation control panel interface. Wherein, the realistic function control panel interface and the realistic operation control panel interface are imitated images generated by computer software.

The software simulator electrically connects the CNC control panel interface, and generates a machining and operation simulation based on a control and operation command received by the realistic operation control panel interface. The simulation displayer is mounted on the CNC casing assembly and electrically connects the software simulator to visualize the machining and operation simulation generated by the software simulator.

In one embodiment, the CNC casing assembly further includes a control box. The control box is arranged with the simulation displayer at the same side of the CNC casing assembly. The CNC control panel interface is settled on the control box.

According to another aspect of the disclosure, an operation training simulation apparatus for the computer numerical control (CNC) machine is disclosed. The operation training simulation apparatus includes a CNC casing assembly, a control panel device, a software simulator and a simulation displayer.

The CNC casing assembly has a CNC frame body. The control panel device is mounted on the CNC casing assembly and has a CNC control panel interface. The software simulator electrically connects the control panel device to generate a machining and operation simulation. The simulation displayer is settled on the CNC frame body and electrically connects the software simulator to visualize the machining and operation simulation generated by the software simulator.

In one embodiment, the CNC control panel interface includes a realistic function control panel interface and a realistic operation control panel interface. The realistic function control panel interface and the realistic operation control panel interface are really CNC operation interfaces or imitated images provided by the computer software.

The CNC control panel interface can be a touch panel displayer and can be operated, and together with the simulation displayer to provide the simulation CNC working environment to the user. It saves the raw material, decreases the risk and also increases the learning efficiency.

The CNC control panel interface touch panel can imitate a realistic function control panel interface and a realistic operation control panel interface. They enable the user to control the producing process and to simulate the result at the same time. It not only helps the user to become, familiar with the CNC tool machine, but also save training costs and training time.

On the other hand, the operation training simulation apparatus not only provides an interface that has the same appearance with a real CNC operation panel, but also provides a CNC casing assembly has the same appearance with a real CNC tool machine. It provides a simulation CNC working environment to the user, and let the user feel like being operating a real CNC tool machine.

### BRIEF DESCRIPTION OF THE DRAWINGS

The disclosure can be more fully understood by reading the following detailed description of the embodiments, with reference made to the accompanying drawings as follows:

FIG. 1 is a system function block of the operation training simulation apparatus of one embodiment of the disclosure.

FIG. 2 is a stereo view of the operation training simulation apparatus of one embodiment of the disclosure.

FIG. 3 is a schematic view of the operation imitating area of the CNC control panel interface in FIG. 2, depicting the realistic function control panel interface and the realistic operation control panel interface.

FIG. 4 is a stereo view of the operation training simulation apparatus of another embodiment of the disclosure.

FIG. 5 is a schematic view of FIG. 4, depicting the state of the operation training simulation apparatus being used.

[Major symbols]

100: operation training simulation apparatus
110: CNC casing assembly
111: CNC frame body
112: control box
113: bracket
114: rolling device
115: recess
120: control panel device
121: CNC control panel interface
122: realistic function control panel interface
123: realistic operation control panel interface
124: electronic hand wheel
125: operation imitating area
130: simulation displayer
140: software simulator

### DETAILED DESCRIPTION

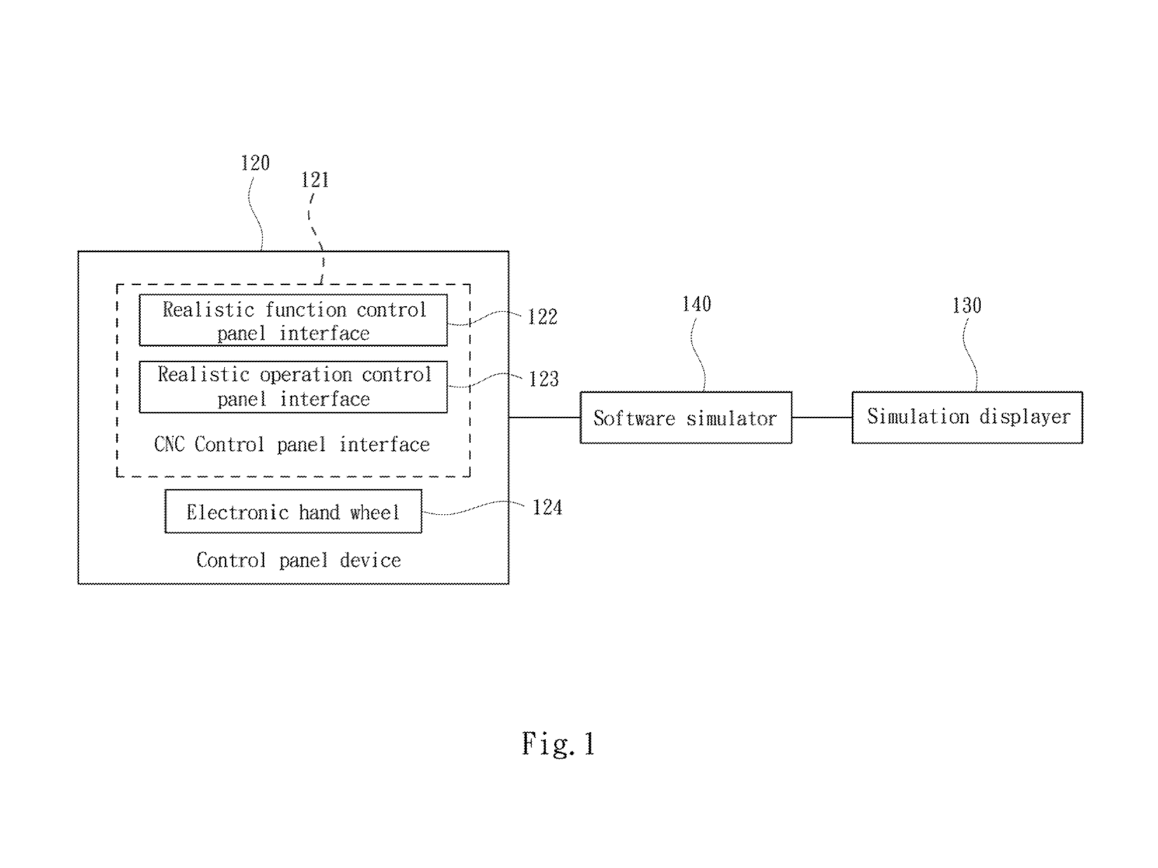

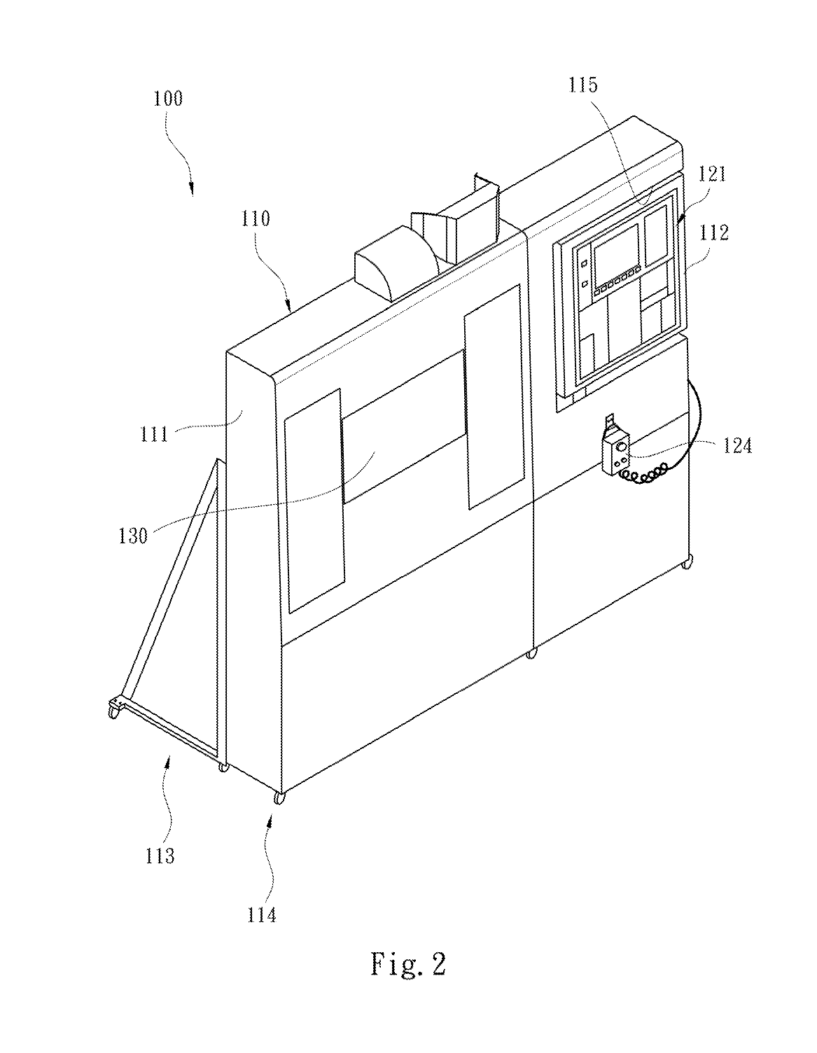

Refer to FIG. 1 and FIG. 2. FIG. 1 is a system function block of the operation training simulation apparatus of one embodiment of the disclosure. FIG. 2 is a stereo view of the operation training simulation apparatus of one embodiment of the disclosure. According to one embodiment of the disclosure, an operation training simulation apparatus 100 for the computer numerical control (CNC) machine is disclosed. The operation training simulation apparatus 100 includes a CNC casing assembly 110, a control panel device 120, a simulation displayer 130 and a software simulator 140.

The CNC casing assembly 110 further includes a CNC frame body 111, a control box 112, a bracket 113 and a rolling device 114. The outer shape of the CNC frame body 111 is the same with a real CNC tool machine. The CNC frame body 111 also has a recess 115. The control box 112 is embedded into the recess 115. In the embodiment, the control box 112 is pivotally installed on the surface of the CNC frame body 111. In other words, the control box 112 can be retrieved in the recess 115 or extend from the recess 115.

The bracket 113 is assembled with the CNC frame body 111 to support the CNC frame body 111 in a standing state. The rolling device 114 includes many rollers, and the rollers are assembled at the bottom of the outer surface of the CNC frame body 111. When the bracket 113 is demounted or retrieved with the CNC frame body 111, the rolling device 114 enables the CNC frame body 111 to be moved easily.

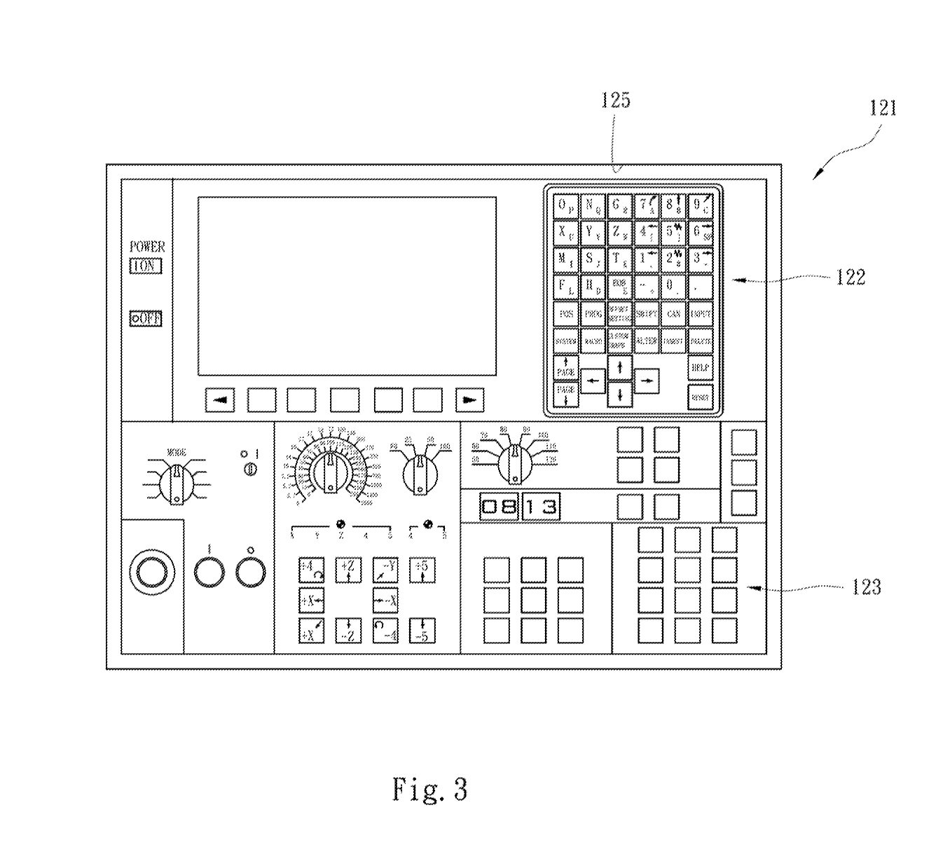

Refer to FIG. 3 for a schematic view of the operation imitating area 125 of the CNC control panel interface 121 in FIG. 2, it depicts the realistic function control panel interface 122 and the realistic operation control panel interface 121. The control panel device 120 is arranged on the CNC casing assembly 110 to provide at least one imitated CNC operation interface. In the embodiment, the control panel device 120 includes a CNC control panel interface 121 and an electronic hand wheel 124. The CNC control panel interface 121 is arranged in the control box 112. In the embodiment, the CNC control panel interface 121 is a touch panel, such as a liquid crystal touch panel displayer. The electronic hand wheel 124 electrically connects the CNC casing assembly 110 via a wire, or being directly embedded in the CNC frame body 111. The electronic hand wheel 124 can be applied to tune the operation and to increase the realistic.

The CNC control panel interface 121 has an operation imitating area 125, the operation imitating area 125 includes a realistic function control panel interface 122 and a realistic operation control panel interface 123. The realistic function control panel interface 122 and the realistic operation control panel interface 123 are imitated images generated by the software. The appearances of the imitated images are the same with the operation interface of the real CNC tool machine. Therefore, the control panel device 120 provides the user a simulation CNC working environment when the user is trained by using the simulation software. On the other hand, the CNC control panel interface 121 can also be replaced by an actual CNC operation interface. For instance, the realistic function control panel interface 122 can be an imitated image, but the realistic operation control panel interface 123 is a real interface which includes buttons and knobs. In another embodiment, the realistic function control panel interface 122 is a real interface which includes buttons, knobs and screen, but the realistic operation control panel interface 123 is an imitated image. In the other embodiment, both the realistic function control panel interface 122 and the realistic operation control panel interface 123 are real interfaces which include buttons, knobs and screen. The realistic function control panel interface 122 is applied to receive the command codes, i.e. the machining and operation simulation orders, for the producing process. The realistic operation control panel interface 123 is applied to switch the operation modes, to control the processing parameters and to control the steps of the executed process. It also has input interfaces such as buttons, switches, knobs and keyboard to receive the operation codes and the numerical control codes.

The simulation displayer 130 is a screen, and the simulation displayer 130 is arranged with the control panel device 120 at the same side of the CNC frame body 111. The simulation displayer 130 is a large size liquid crystal displayer (LCD), a plasma displayer or a three dimensional displayer.

Therefore, the user enters a machining and operation simulation command which includes the command codes, the parameters, etc. via the control panel device 120. The software simulator 140 generates a machining and operation simulation based on the control and operation command, and the simulation displayer 130 visualizes the machining and operation simulation.

For instance, when the user inputs a feeding knife command through the realistic operation control panel interface 123, the software simulator 140 simulates the movement of the feeding knife command. Therefore, the operation training simulation apparatus 100 provides a simulation CNC working environment to the user. The simulation displayer 130 enables the user to recognize what his command will do, and enables the user to correct the parameters immediately. On the other hand, the operation training simulation apparatus 100 provides a learning environment that has no risk, and has no raw material cost.

The buttons, the switches, the knobs and the indicating lights of the control panel device 120 can be arranged at the same location with the CNC operation interface. In other words, they look alike. In detail, when the control panel device 120 is applied to imitate the CNC lathe tool, the operation imitating area 125 of the control panel device 120 is imitated to have the same appearance with the operation interface of the CNC lathe tool. When the control panel device 120 is applied to imitate the CNC miller tool, the operation imitating area 125 of the control panel device 120 is imitated to have the same appearance with the operation interface of the CNC miller tool. What is worth to notice is that the appearance of the control panel device 120 in FIG. 3 is merely an example, not intended to restrict the embodiment.

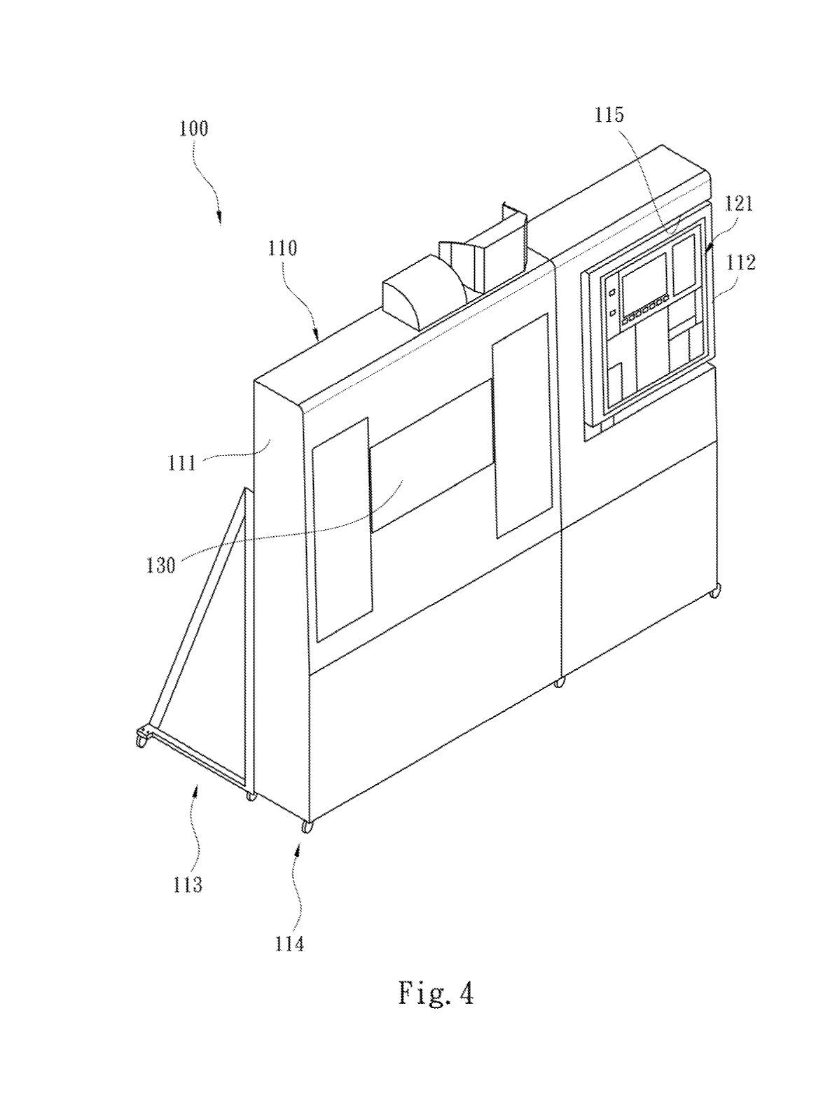

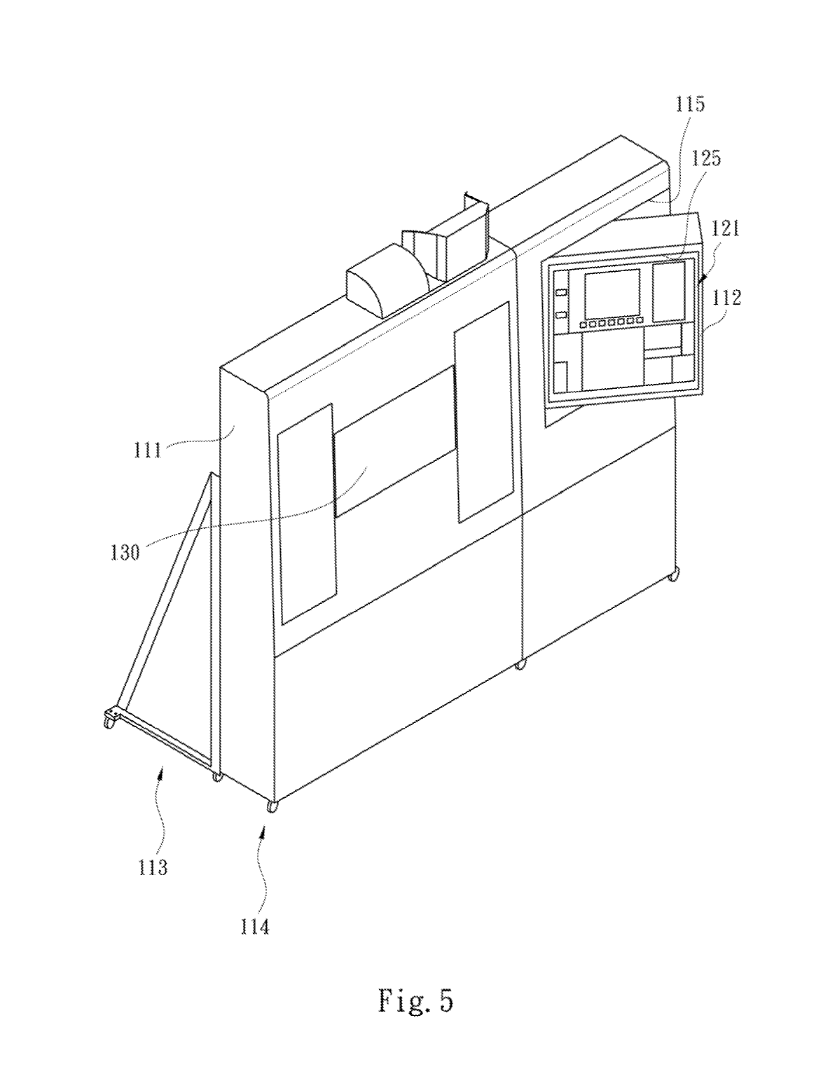

Refer to FIG. 4 and FIG. 5. FIG. 4 is a stereo view of the operation training simulation apparatus of another embodiment of the disclosure. FIG. 5 is a schematic view of FIG. 4, and it depicts the state of the operation training simulation apparatus being used. The difference between this embodiment and the embodiment in FIG. 2 is the electronic hand wheel being omitted from the CNC control panel interface 121. The CNC control panel interface 121 without the electronic hand wheel can be applied to imitate many kinds of CNC panels.

When the user practices the operation via the realistic function control panel interface 122 and the realistic operation control panel interface 123, the simulation displayer 130 real time simulates the movements to provide better realistic feeling. The simulation displayer 130 can be a three dimensional displayer, and the three dimensional displayer can be a laser three dimensional displayer. In detail, the simulated movements, i.e. the machining and operation simulations, are projected, by lasers to establish the simulation CNC working environment.

As being described above, the control panel device 120 can be an imitated image or a real CNC operation interface panel. The realistic function control panel interface 122 and the realistic operation control panel interface 123 can be touch panels.

The software simulator 140 graphically simulates the shapes and the movements of the tools and the producing processes in a real CNC tool machine. Furthermore, the software simulator 140 simulates the parameters such as the time, the angel, etc. What is worth noticing is the simulating images can be zoomed in or zoomed out to help the user to observe the processing details directly and immediately. This is a great benefit for the user to learn the operation of the CNC tool machine.

As being described by the embodiments above. The disclosure provides many benefits as following.

The realistic function control panel interface and the realistic operation control panel interface enable the user to become familiar with the operation interface panel of the real CNC tool machine.

The simulation displayer, together with the realistic function control panel interface and the realistic operation control panel interface, provide a simulation CNC working environment to show out the simulated processes, images, required time, cutting condition, etc. What is worth noticing is the simulating images can be zoomed in to help the user to observe the processing details directly and immediately. This is a great benefit for the user to learn the operation of the CNC tool machine.

The imitated realistic function control panel interface and realistic operation control panel interface enable a user to focus on the actual producing processes of a CNC tool machine, without wasting time to learn the software of the simulator.

The realistic function control panel interface and the realistic operation control panel interface increase the proficiency when a user or a student learns to be a CNC operator.

The operation training simulation apparatus saves lots of cost and raw material when training a user.

The operation training simulation apparatus prevents the user from being hurt or damage the CNC tool machine due to their unskilled operation.

The operation training simulation apparatus provide a simulation CNC working environment to increase the realistic of the simulation. The operation training simulation apparatus displays images alike the real process of the CNC tool machine, and the profile of the operation training simulation apparatus looks almost the same with a real CNC tool machine.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

### INDUSTRIAL UTILITY

The application uses the realistic function control panel interface, the realistic operation control panel interface and the simulation displayer to provide a simulation CNC working environment, and thus saves lots of cost and raw material when training a user and prevents the user from being hurt or damage the CNC tool machine due to their unskilled operation.

At the same time, the application enables a user to focus on the actual producing processes of a CNC tool machine, without wasting time to learn the software of the simulator. Therefore, the proficiency is increased when a user or a student learns to be a CNC operator.

On the other hand, the operation training simulation apparatus displays images alike the real process of the CNC tool machine, and the profile of the operation training simulation apparatus looks almost the same with a real CNC tool machine.

What is claimed is:

1. An operation training simulation apparatus for the computer numerical control (CNC) machine, the operation training simulation apparatus comprising:
a CNC casing assembly comprising a CNC frame body;
a control panel device being mounted on the CNC casing assembly and comprising a CNC control panel interface, the CNC control panel interface comprising an operation imitating area, and the operation imitating area comprising a realistic function control interface and a realistic operation control panel interface;
a software simulator electrically connecting the CNC control panel interface, and generating a machining and operation simulation based on a control and operation command received by the realistic operation control panel interface; and
a simulation displayer being mounted on the CNC casing assembly and electrically connecting the software simulator to visualize the machining and operation simulation generated by the software simulator.

2. The operation training simulation apparatus of claim 1, the CNC casing assembly further comprising a control box, the control box being arranged with the simulation displayer at the same side of the CNC casing assembly, the CNC control panel interface being settled on the control box, the CNC frame body comprising a recess, and the control box being pivotally embedded into the recess.

3. The operation training simulation apparatus of claim 1, wherein the simulation displayer is a liquid crystal displayer (LCD).

4. The operation training simulation apparatus of claim 1, wherein the simulation displayer is a plasma displayer.

5. The operation training simulation apparatus of claim 1, wherein the simulation displayer is a three dimensional displayer.

6. The operation training simulation apparatus of claim 1, wherein the simulation displayer is a touch panel displayer.

7. The operation training simulation apparatus of claim 1, the control panel device further comprising an electronic hand wheel.

8. The operation training simulation apparatus of claim 1, the CNC casing assembly further comprising a bracket and a rolling device, the bracket being assembled at one side that not being mounted by the simulation displayer of the CNC frame body, the rolling device comprising a plurality of rollers, and the rollers being assembled at the bottom of the outer surface of the CNC frame body.

9. An operation training simulation apparatus for the computer numerical control (CNC) machine, the operation training simulation apparatus comprising:
a CNC casing assembly comprising a CNC frame body;
a control panel device being mounted on the CNC casing assembly and comprising a CNC control panel interface;
a software simulator electrically connecting the control panel device to generate a machining and operation simulation; and
a simulation displayer electrically connecting the software simulator to visualize the machining and operation simulation generated by the software simulator.

10. The operation training simulation apparatus of claim 9, the CNC casing assembly further comprising a control box, the control box being arranged with the simulation displayer at the same side of the CNC casing assembly, the CNC control panel interface being settled on the control box, the CNC frame body comprising a recess, and the control box being pivotally embedded into the recess.

11. The operation training simulation apparatus of claim 9, wherein the simulation displayer is a liquid crystal displayer (LCD).

12. The operation training simulation apparatus of claim 9, wherein the simulation displayer is a plasma displayer.

13. The operation training simulation apparatus of claim 9, wherein the simulation displayer is a three dimensional displayer.

14. The operation training simulation apparatus of claim 9, the CNC control panel interface further comprising a realistic function control interface and a realistic operation control panel interface, at least one of the realistic function control interface and the realistic operation control panel interface being a virtual image.

15. The operation training simulation apparatus of claim 9, the control panel device further comprising an electronic hand wheel.

16. The operation training simulation apparatus of claim 9, the CNC casing assembly further comprising a bracket and a rolling device, the bracket being assembled at one side that not being mounted by the simulation displayer of the CNC frame body, the rolling device comprising a plurality of rollers, and the rollers being assembled at the bottom of the outer surface of the CNC frame body.
